(19) United States
(12) Patent Application Publication
(10) Pub. No.: US 2025/0329281 A1
(43) Pub. Date: Oct. 23, 2025

(54) DISPLAY PANEL, DRIVING METHOD THEREOF, AND DISPLAY DEVICE

(71) Applicant: Tianma Advanced Display Technology Institute (Xiamen) Co., Ltd., Xiamen (CN)

(72) Inventors: Yingteng ZHAI, Xiamen (CN); Feng QIN, Xiamen (CN); Xuhui PENG, Xiamen (CN)

(73) Assignee: Tianma Advanced Display Technology Institute (Xiamen) Co., Ltd., Xiamen, FJ (CN)

(21) Appl. No.: 19/256,649

(22) Filed: Jul. 1, 2025

(30) Foreign Application Priority Data
Oct. 30, 2024 (CN) 202411533522.8

(51) Int. Cl. G09G 3/20

(52) U.S. Cl. CPC G09G 3/2074; G09G 2300/026; G09G 2310/08; G09G 2320/0233; G09G 2330/021

(57) ABSTRACT

Provided are a display panel, a driving method thereof, and a display device, which relate to the field of display technology, for improving the display uniformity of the display panel. The display panel includes sub-pixels, one of which receives a first light emitting control signal. The display panel is characterized by at least a first time and a second time that are different from each other. The first time and the second time are light emitting times of different sub-pixels; or the first time and the second time are turn-on times of the first light emitting control signal of different sub-pixels; or the first time and the second time are light emitting times of a same sub-pixel in different states; or the first time and the second time are turn-on times of the first light emitting control signal of a same sub-pixel in different states.

### CROSS-REFERENCE TO RELATED APPLICATIONS

The present application claims priority to Chinese Patent Application No. 202411533522.8, filed on Oct. 30, 2024, the content of which is incorporated herein by reference in its entirety.

### TECHNICAL FIELD

The present disclosure relates to the field of display technology, and in particular, to a display panel, a driving method thereof, and a display device.

### BACKGROUND

With continuous development of science and technology, more and more display devices are widely used in people's daily life and work, and become an indispensable and important tool for people today. Moreover, with the continuous development of display technology, the requirements of consumers for displayers have been continuously increased, and various types of displayers are emerging endlessly, such as organic light emitting diode (OLED), mini light emitting diode (Mini LED), and micro light emitting diode (Micro LED). Currently, a display panel has a problem of display non-uniformity (Mura).

### SUMMARY

In view of this, the present disclosure provides a display panel, a driving method thereof, and a display device to improve display uniformity of the display panel.

In an aspect, an embodiment of the present disclosure provides a display panel, including sub-pixels, one of which receives a first light emitting control signal. The display panel is characterized by at least a first time and a second time that are different from each other. The first time and the second time are light emitting times of different sub-pixels, or the first time and the second time are turn-on times of the first light emitting control signals of different sub-pixels, or the first time and the second time are light emitting times of a same sub-pixel in different states, or the first time and the second time are turn-on times of the first light emitting control signal of a same sub-pixel in different states.

In another aspect, an embodiment of the present disclosure provides a display device including a display panel. The display panel includes sub-pixels, one of which receives a first light emitting control signal. The display panel is characterized by at least a first time and a second time that are different from each other. The first time and the second time are light emitting times of different sub-pixels, or the first time and the second time are turn-on times of the first light emitting control signals of different sub-pixels, or the first time and the second time are light emitting times of a same sub-pixel in different states, or the first time and the second time are turn-on times of the first light emitting control signal of a same sub-pixel in different states.

In another aspect, an embodiment of the present disclosure provides a driving method of a display panel. The display panel includes sub-pixels, one of which receives a first light emitting control signal. The display panel is characterized by at least a first time and a second time that are different from each other. The first time and the second time are light emitting times of different sub-pixels, or the first time and the second time are turn-on times of the first light emitting control signals of different sub-pixels, or the first time and the second time are light emitting times of a same sub-pixel in different states, or the first time and the second time are turn-on times of the first light emitting control signal of a same sub-pixel in different states. The driving method includes: controlling the display panel to at least have the first time and the second time that are different from each other.

According to some embodiments of the present disclosure, when the first time and the second time are the light emitting time of different sub-pixels in the display panel, or are the turn-on time of the first light emitting control signals of different sub-pixels in the display panel, a brightness difference caused by factors such as different light emitting moments or different threshold voltage drifts of different sub-pixels can be compensated by making the first time and the second time different from each other, thereby improving the display consistency of different regions of the display panel.

According to some embodiments of the present disclosure, when the first time and the second time are the light emitting time of a same sub-pixel in different states, or the first time and the second time are the turn-on time of the first light emitting control signal of a same sub-pixel in different states, the first time and the second time are different from each other, thereby avoiding a possible flicker caused by different brightness of the display panel at different moments.

### BRIEF DESCRIPTION OF DRAWINGS

In order to more clearly illustrate the technical solutions in the embodiments of the present disclosure, the drawings, which are intended to be used in the description of the embodiments, are briefly described as below. It will be apparent that other drawings described below are merely some embodiments of the present disclosure, and other drawings may be obtained by those skilled in the art according to these drawings.

FIG. 1 is a circuit diagram of a sub-pixel according to an embodiment of the present disclosure;

FIG. 2 is an operation timing diagram of two different sub-pixels in a display panel according to an embodiment of the present disclosure;

FIG. 3 is a circuit diagram of another sub-pixel according to an embodiment of the present disclosure;

FIG. 4 is another operation timing diagram of two different sub-pixels in a display panel according to an embodiment of the present disclosure;

FIG. 5 is a circuit diagram of yet another sub-pixel according to an embodiment of the present disclosure;

FIG. 6 is an operation timing diagram of the pixel driving circuit shown in FIG. 5;

FIG. 7 is another operation timing diagram of the pixel driving circuit shown in FIG. 5;

FIG. 8 is yet another operation timing diagram of the pixel driving circuit shown in FIG. 5;

FIG. 9 is yet another operation timing diagram of two different sub-pixels in a display panel according to an embodiment of the present disclosure;

FIG. 10 is a schematic diagram of a display panel according to an embodiment of the present disclosure;

FIG. 11 is a schematic diagram of a display portion according to an embodiment of the present disclosure;

FIG. 12 is a schematic diagram of another display panel according to an embodiment of the present disclosure;

FIG. 13 is an operation timing diagram of a display panel according to an embodiment of the present disclosure;

FIG. 14 is an operation timing diagram of another display panel according to an embodiment of the present disclosure;

FIG. 15 is an operation timing diagram of yet another display panel according to an embodiment of the present disclosure; and

FIG. 16 is a schematic diagram of a display device according to an embodiment of the present disclosure.

### DESCRIPTION OF EMBODIMENTS

In order to better understand the technical solutions of the present disclosure, embodiments of the present disclosure are described in detail as follows with reference to the drawings.

It should be noted that, the described embodiments are merely some of, rather than all of the embodiments of the present disclosure. All other embodiments obtained by those skilled in the art according to the embodiments of the present disclosure shall fall within a scope of the present disclosure.

The terms used in the embodiments of the present disclosure are only for the purpose of describing specific embodiments, and are not intended to limit the present disclosure. Unless otherwise noted in the context, the singular form expressions “a”, “an”, “the”, and “said” used in the embodiments and appended claims of the present disclosure are also intended to represent plural form expressions thereof.

It should be understood that the term “and/or” used herein is merely an association relationship describing an associated object, and indicates that there may be three relationships, for example, A and/or B, and may indicate: only A, both A and B, and only B. In addition, the character “/” herein generally means an “or” relationship between the associated objects.

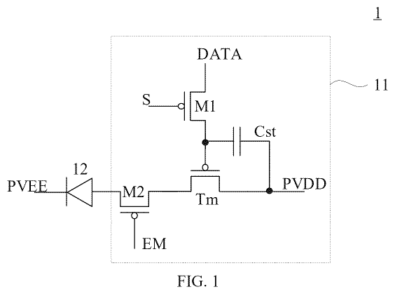

An embodiment of the present disclosure provides a display panel that includes sub-pixels. As shown in FIG. 1, which is a circuit diagram of a sub-pixel according to an embodiment of the present disclosure, the sub-pixel 1 includes a pixel driving circuit 11 and a light emitting element 12 that are electrically connected to each other. Exemplarily, the light emitting element 12 can be a light emitting diode (LED) that includes a mini light emitting diode (mini LED), a micro light emitting diode (Micro LED), or an organic light emitting diode (OLED), which may be designed according to actual conditions during specific implementation.

As shown in FIG. 1, the sub-pixel 1 receives a first light emitting control signal EM that can control light emitting time of the sub-pixel 1. When the first light emitting control signal EM is at an enable level, a driving current generated by the pixel driving circuit 11 flows through the light emitting element 12, and the light emitting element 12 lights up. When the first light emitting control signal EM is at a non-enable level, the driving current no longer flows through the light emitting element 12, and the light emitting element 12 is in an off state. The brightness of the light emitting element 12 is related to the magnitude of the driving current flowing through the light emitting element 12 and a light emitting duration of the light emitting element in one frame period.

In an embodiment of the present disclosure, the display panel at least has first time and second time that are different from each other. Exemplarily, the first time and the second time are light emitting time of different sub-pixels in the display panel. Taking the sub-pixels in the display panel including a first sub-pixel and a second sub-pixel as an example, light emitting time of the first sub-pixel may be first time, and light emitting time of the second sub-pixel may be second time. The light emitting time refers to light emitting duration, and the light emitting duration is a duration in which the first light emitting control signal EM is at an enable level in one frame period.

Alternatively, the first time and the second time are the turn-on time of the first light emitting control signal EM of different sub-pixels in the display panel. The turn-on time can be understood as the turn-on moment, that is, a moment when the first light emitting control signal EM switches from a non-enable level to an enabled level. For example, when the enable level of the first light emitting control signal EM is a low level, the turn-on time of the first light emitting control signal EM is the time at which a falling edge of the first light emitting control signal EM is located.

Alternatively, the first time and the second time are light emitting time of a same sub-pixel in different states. The different states can include different periods. Exemplarily, the different periods include different frame periods. For example, a frame period corresponding to a sub-pixel is a data refresh period. Alternatively, when a frame period includes a plurality of sub-frames, the different periods may be different sub-frames within a frame period. Taking the different states including a first state and a second state as an example, the first time is light emitting time of the sub-pixel in the first state, and the second time is light emitting time of the same sub-pixel in the second state.

Alternatively, the first time and the second time are turn-on time of the first light emitting control signal EM of a same sub-pixel in different states. For example, the first time is turn-on time of the first light emitting control signal EM provided to a sub-pixel in a first state, and the second time is turn-on time of the first light emitting control signal EM provided to the sub-pixel in a second state that is different from the first state.

It should be noted herein that the turn-on time of a signal refers to the time during which the signal jumps and remains in a turn-on state of a switch (i.e., a thin film transistor) controlled correspondingly.

In the embodiments of the present disclosure, the first time and the second time are the light emitting time of different sub-pixels in the display panel, or are the turn-on time of the first light emitting control signal of different sub-pixels in the display panel, in this case, a brightness difference caused by factors such as different light emitting moments or different threshold voltage drifts of different sub-pixels can be compensated by making the first time and the second time be different from each other, so that actual brightness of different sub-pixels tends to be consistent, thereby improving display consistency of different regions of the display panel. The actual brightness can be detected by a brightness detection instrument, and the actual brightness refers to the brightness displayed after taking into account influence factors, such as different light emitting moments or threshold voltage drifts of the sub-pixels.

In an embodiment of the present disclosure, the first time and the second time are the light emitting time of a same sub-pixel in different states, or the first time and the second time are the turn-on time of the first light emitting control signal of a same sub-pixel in different states, in this case, the first time and the second time are different from each other, so that the actual brightness of a same sub-pixel in different states tends to be consistent, thereby avoiding a flicker problem caused by different brightness of the display panel at different moments.

Exemplarily, at a same target grayscale, the first time is different from the second time. In other words, for the sub-pixels in two different regions that are supposed to display a same target grayscale, the sub-pixels actually correspond to the first time and the second time, respectively. Alternatively, a same sub-pixel is supposed to display a same target grayscale in two different states, which actually correspond to the first time and the second time, respectively. That is, the first time and the second time being different refers to a difference in time under a common reference standard at a same target grayscale. The target grayscale is related to image data received by the display panel, and the target grayscale can be regarded as an ideal grayscale that the sub-pixel is expected to achieve. According to the embodiments of the present disclosure, the first time and the second time at a same target grayscale are different from each other, so that the brightness difference caused by factors such as different light emitting moments or different threshold voltage drifts of the sub-pixels can be compensated, thereby improving the display consistency in the different regions of the display panel, or avoiding the flicker problem caused by the different brightness of the display panel at different moments. It is understandable that the adjustment of the actual display grayscale or the light emitting brightness perceived by naked eyes may result, thereby compensating for the brightness difference in different regions.

It should be noted that the determination of the target grayscale is described in detail below and will not be repeated herein.

When configuring the pixel driving circuit 11, in an optional implementation, as shown in FIG. 1, the pixel driving circuit 11 at least includes a driving transistor Tm, a data writing transistor M1, a light emitting control transistor M2, and a storage capacitor Cst. In one frame period, an operation process of the pixel driving circuit 11 includes a data writing phase and a light emitting phase. In the data writing phase, the data writing transistor M1 is turned on under the control of the scanning signal S to write the data signal DATA into the gate of the driving transistor Tm. In the light emitting phase, the light emitting control transistor M2 is turned on under the control of the first light emitting control signal EM, and the driving transistor Tm generates the driving current under the control of a gate voltage thereof and the driving current is provided to the light emitting element 12.

It is also necessary to provide a first power signal PVDD and a second power signal PVEE to drive the light emitting element 12 to emit light. For example, the first power signal PVDD is a positive power voltage, and the second power signal PVEE is a negative power voltage. In an embodiment of the present disclosure, the driving current Id flowing through the light emitting element 12 satisfies: Id=K1(Vgs-Vth)², where K1 represents a constant related to a characteristic of the driving transistor Tm, Vgs represents a gate-source voltage difference of the driving transistor Tm, and Vth represents a threshold voltage of the driving transistor Tm. In an embodiment of the present disclosure, as shown in FIG. 1, the gate of the driving transistor Tm is electrically connected to a data signal line DATA, and a first electrode of the driving transistor Tm is electrically connected to a first power signal line PVDD. That is, the data signal DATA and the first power signal PVDD affect the driving current Id generated by the driving transistor Tm, thereby affecting the brightness of the light emitting element 12. In an embodiment of the present disclosure, the duration during which a driving current Id flows through the light emitting element 12 can be adjusted by adjusting the duration during which the first light emitting control signal EM is at the enable level in a frame period, thereby adjusting the light emitting time of the light emitting element 12 and achieving adjustment of the brightness of the light emitting element 12. In an example, in an embodiment of the present disclosure, the time for the driving current Id to flow through the light emitting element 12 can be adjusted by adjusting the turn-on time of the first light emitting control signal EM to the enable level, thereby adjusting the light emitting time of the light emitting element 12 and adjusting the brightness of the light emitting element 12.

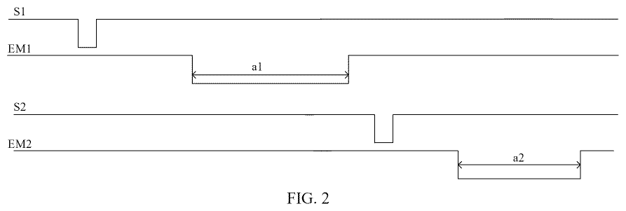

For example, as shown in FIG. 2, which is an operation timing diagram of two different sub-pixels in the display panel according to an embodiment of the present disclosure, the two sub-pixels are a first sub-pixel and a second sub-pixel, respectively, and both of the first sub-pixel and the second sub-pixel can adopt the circuit structure shown in FIG. 1. In FIG. 2, S1 represents a scanning signal provided to the first sub-pixel, S2 represents a scanning signal provided to the second sub-pixel, EM1 represents a first light emitting control signal provided to the first sub-pixel, and EM2 represents a first light emitting control signal provided to the second sub-pixel. FIG. 2 illustrates that the enable level of the first light emitting control signal EM is a low level. As shown in FIG. 2, the light emitting time of the first sub-pixel is a1, and the light emitting time of the second sub-pixel is a2, where a1≠a2. FIG. 2 illustrates that a1>a2, to compensate for the brightness difference caused by factors such as different light emitting moments or different threshold voltage drifts of the first sub-pixel and the second sub-pixel, thereby improving the display consistency of different regions of the display panel.

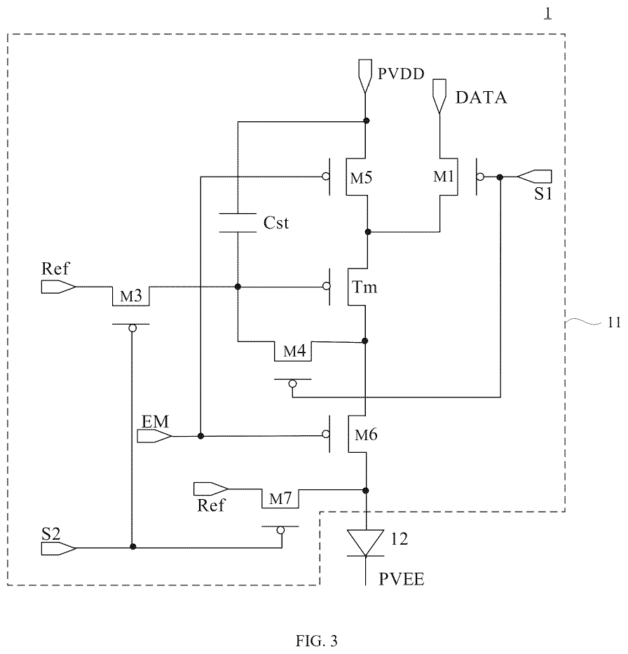

In another optional implementation, as shown in FIG. 3, which is a circuit diagram of another sub-pixel according to an embodiment of the present disclosure, the pixel driving circuit 11 includes a driving transistor Tm, a data writing transistor M1, a gate reset transistor M3, a threshold compensation transistor M4, an electrode reset transistor M7, a first light emitting control transistor M5, a second light emitting control transistor M6, and a storage capacitor Cst. In one frame period, the operation process of the pixel driving circuit 11 at least includes a reset phase, a data writing phase and a light emitting phase.

In the reset phase, the gate reset transistor M3 is turned on under the control of the second scanning signal S2 to write a reset signal Ref into the gate of the driving transistor Tm, and the electrode reset transistor M7 is turned on under the control of the second scanning signal S2 to write the reset signal Ref into the anode of the light emitting element 12.

In the data writing phase, the data writing transistor M1 and the threshold compensation transistor M4 are turned on under the control of the first scanning signal S1, to write the first data signal DATA into the gate of the driving transistor Tm, and to self-check and compensate the threshold voltage of the driving transistor Tm.

In the light emitting phase, the first light emitting control transistor M5 and the second light emitting control transistor M6 are turned on under the control of the first light emitting control signal EM, and the driving transistor Tm generates the driving current under the control of the gate voltage thereof and the driving current is provided to the light emitting element 12. The driving current Id satisfies: Id=K2(V_{DATA}-V_{PVDD})², where K2 represents a constant related to a characteristic of the driving transistor Tm, V_{DATA} represents a voltage value of the first data signal DATA, and V_{PVDD} represents a voltage value of the first power signal PVDD. In an embodiment of the present disclosure, the duration during which a driving current Id flows through the light emitting element 12 can be adjusted by adjusting the time during which the first light emitting control signal EM is at an enable level in a frame period, thereby adjusting the light emitting time of the light emitting element 12 and achieving adjustment of the brightness of the light emitting element 12. In an example, in an embodiment of the present disclosure, the time for the driving current Id to flow through the light emitting element 12 can be adjusted by adjusting the turn-on time of the enable level provided by the first light emitting control signal EM, thereby adjusting the light emitting time of the light emitting element 12 and adjusting the brightness of the light emitting element 12.

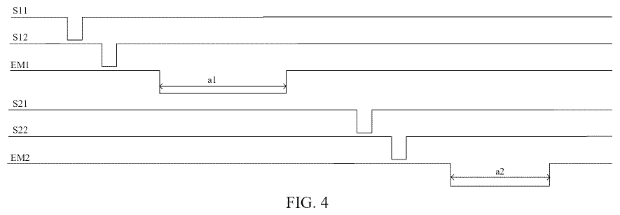

For example, as shown in FIG. 4, which is another operation timing diagram of two different sub-pixels in the display panel according to an embodiment of the present disclosure, two sub-pixels are a first sub-pixel and a second sub-pixel, respectively, and both of the first sub-pixel and the second sub-pixel can adopt the circuit structure shown in FIG. 3. In FIG. 4, S11 represents a first scanning signal provided to the first sub-pixel, S12 represents a second scanning signal provided to the first sub-pixel, EM1 represents a first light emitting control signal provided to the first sub-pixel, S21 represents a first scanning signal provided to the second sub-pixel, S22 represents a second scanning signal provided to the second sub-pixel, and EM2 represents a first light emitting control signal provided to the second sub-pixel. As shown in FIG. 4, the light emitting time of the first sub-pixel is a1, and the light emitting time of the second sub-pixel is a2, where a1≠a2. FIG. 4 illustrates that a1>a2, to compensate for the brightness difference caused by factors such as different light emitting moments or different threshold voltage drifts of the first sub-pixel and the second sub-pixel, thereby improving the display consistency of different regions of the display panel.

It can be understood that the pixel driving circuit 11 shown in FIG. 1 and FIG. 2 is only schematic, and is not intended to limit the present disclosure. The pixel driving circuit 11 in the display panel provided by the present disclosure can adopt any circuit structure that can change the duration of the driving current flowing through the light emitting element 12 by adjusting the first light emitting control signal.

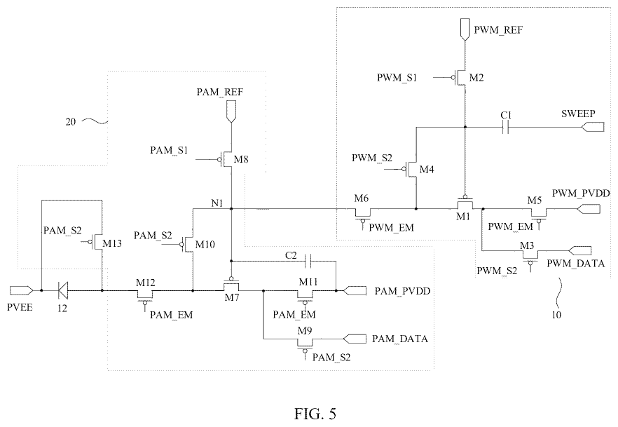

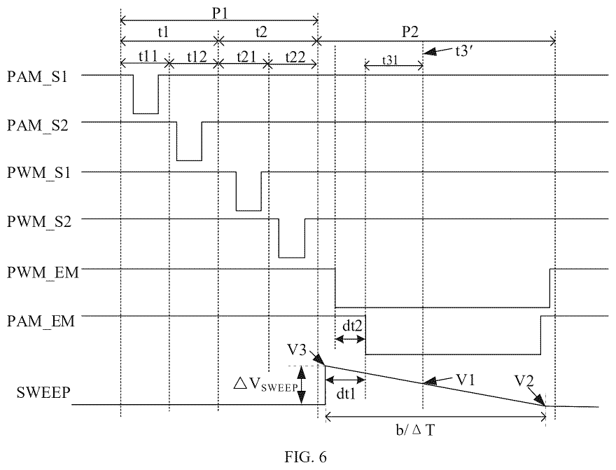

Exemplarily, as shown in FIG. 5 and FIG. 6, FIG. 5 is a circuit diagram of another sub-pixel according to an embodiment of the present disclosure, and FIG. 6 is an operation timing diagram of the pixel driving circuit shown in FIG. 5, the pixel driving circuit includes a second driving transistor M7, a pulse width modulation (PWM) module 10 and a pulse amplitude modulation (PAM) module 20 that are electrically connected, and the pulse amplitude modulation module 20 is electrically connected to the light emitting element 12.

The pixel driving circuit 11 generates a driving current with an adjustable duration under the control of the pulse amplitude modulation module 20 and the pulse width modulation module 10. In an example, the second driving transistor M7 is configured to output a driving current according to a signal at a gate of the second driving transistor M7 and a signal at a first terminal of the second driving transistor M7. The pulse amplitude modulation module 20 corresponds to a first light emitting control signal PAM_EM, that is, the pulse amplitude modulation module 20 receives the first light emitting control signal PAM_EM. The pulse width modulation module 10 corresponds to a second signal, that is, the pulse width modulation module 10 receives the second signal. The second signal is another signal provided to the sub-pixel in addition to the first light emitting control signal PAM_EM and can affect the light emitting time of the sub-pixel. Exemplarily, the second signal includes a swept-frequency signal SWEEP and/or a second light emitting control signal PWM_EM.

Exemplarily, in an embodiment of the present disclosure, the pulse width modulation module 10 is configured to output a pulse width setting signal to a first terminal of the pulse amplitude modulation module 20 based on the second data signal PWM_DATA and the swept-frequency signal SWEEP under the control of the second light emitting control signal PWM_EM, so as to control the duration of providing the driving current to the light emitting element 12. As shown in FIG. 5, a first terminal of the pulse amplitude modulation module 20 is electrically connected to a first node N1.

The pulse amplitude modulation module 20 is configured to control the light emitting element 12 to emit light in response to the driving current under the control of the first light emitting control signal PAM_EM. When the first light emitting control signal PAM_EM is at an enable level, the driving current flows through the light emitting element 12, and the light emitting element 12 lights up. When the first light emitting control signal PAM_EM is at a non-enable level, the driving current cannot flow through the light emitting element 12, and the light emitting element 12 is in an off state.

For example, as shown in FIG. 5, the pulse width modulation module 10 includes a first driving transistor M1, a first gate reset transistor M2, a first data writing transistor M3, a first compensation transistor M4, a first light emitting control transistor M6, a second light emitting control transistor M5, and a first capacitor C1.

The second light emitting control transistor M5 is connected between a second power signal line PWM_PVDD and a first electrode of the first driving transistor M1, and the first light emitting control transistor M6 is connected between a second electrode of the first driving transistor M1 and the first node N1. The first data writing transistor M3 is connected between a second data signal line PWM_DATA and the first electrode of the first driving transistor M1, the first compensation transistor M4 is connected to the second electrode and the gate of the first driving transistor M1, and the first gate reset transistor M2 is connected to the gate of the first driving transistor M1 and the pulse width reset signal line PWM_REF. A first electrode plate of the first capacitor C1 is connected to the gate of the first driving transistor M1, and a second electrode plate of the first capacitor C1 receives the swept-frequency signal SWEEP. A gate of the first gate reset transistor M2 receives a first pulse width scanning signal PWM_S1, and the gate of the first data writing transistor M3 and the gate of the first compensation transistor M4 each receive a second pulse width scanning signal PWM_S2. A gate of the first light emitting control transistor M6 and a gate of the second light emitting control transistor M5 each receive a second light emitting control signal PWM_EM.

The pulse amplitude modulation module 20 includes a second gate reset transistor M8, a second data writing transistor M9, a second compensation transistor M10, a third light emitting control transistor M11, a fourth light emitting control transistor M12, an electrode reset transistor M12, and a second capacitor C2.

The third light emitting control transistor M11 is connected between the first power signal line PAM_PVDD and a first electrode of the second driving transistor M7, and the fourth light emitting control transistor M12 is connected between a second electrode of the second driving transistor M7 and the light emitting element 12. The second driving transistor M7 is configured to generate a driving current under control of a gate voltage thereof, and a gate of the second driving transistor M7 is electrically connected to the first node N1, to receive the pulse width setting signal output by the pulse width modulation module 10. The second data writing transistor M9 is connected between the first data signal line PAM_DATA and the first electrode of the second driving transistor M7. The second compensation transistor M10 is connected to the second electrode and the gate of the second driving transistor M7, the second gate reset transistor M8 is connected to the gate of the second driving transistor M7 and a pulse amplitude reset signal line PAM_REF, the electrode reset transistor M13 is connected to the first electrode of the light emitting element 12, the fourth light emitting control transistor M12 is connected to the first electrode of the light emitting element 12, and the second electrode of the light emitting element 12 is connected to a third power signal line PVEE. A gate of the second gate reset transistor M8 receives a first pulse amplitude scanning signal PAM_S1. A Gate of the second data writing transistor M9, a gate of the second compensation transistor M10, and a gate of the electrode reset transistor M13 each receive a second pulse amplitude scanning signal PAM_S2. A gate of the third light emitting control transistor M11 and a gate of the fourth light emitting control transistor M12 each receive a first light emitting control signal PAM_EM.

It should be noted that FIG. 5 shows a first electrode of the electrode reset transistor M13 being connected to the third power signal line PVEE, which is merely for illustration. In some other embodiments of the present disclosure, the first electrode of the electrode reset transistor M13 can receive a pulse amplitude reset signal PAM_REF, that is, the first electrode of the electrode reset transistor M13 and the first electrode of the second gate reset transistor M8 receive same signal. In some other embodiments of the present disclosure, the first electrode of the electrode reset transistor M13 is not connected to the third power signal line PVEE, and the first electrode of the electrode reset transistor M13 and the first electrode of the second gate reset transistor M8 receive different signals, which are not illustrated herein.

Exemplarily, as shown in FIG. 6, in one frame period, the operation process of the pixel driving circuit 11 includes a data writing phase P1 and a light emitting phase P2. For example, the data writing phase P1 can include a first writing phase t1 and a second writing phase t2. For example, a frame period corresponding to a sub-pixel is a data refresh period, that is, a period of the first writing phase t1.

In the first writing phase t1, the pulse amplitude modulation module 20 sequentially performs a first gate reset phase t11 and a first data writing phase t12.

In the first gate reset phase t11, the first pulse amplitude scanning signal PAM_S1 is at an enable level, the second gate reset transistor M8 is turned on, and the pulse amplitude reset signal PAM_REF is written into the gate of the second driving transistor M7 through the second gate reset transistor M8, to reset the gate of the second driving transistor M7.

In the first data writing phase t12, the second pulse amplitude scanning signal PAM_S2 is at an enable level, the second data writing transistor M9 and the second compensation transistor M10 are turned on, the first data signal PAM_DATA is written into the gate of the second driving transistor M7 through the second data writing transistor M9 and the second compensation transistor M10, and threshold compensation is performed. For example, in this phase, the electrode reset transistor M13 is turned on to reset the electrode of the light emitting element 12.

In the second writing phase t2, the pulse width modulation module 10 sequentially performs a second gate reset phase t21 and a second data writing phase t22.

In the second gate reset phase t21, the first pulse width scanning signal PWM_S1 is at an enable level, the first gate reset transistor M2 is turned on, and the pulse width reset signal PWM_REF is written into the gate of the first driving transistor M1 through the first gate reset transistor M2, to reset the gate of the first driving transistor M1.

In the second data writing phase t22, the second pulse width scanning signal PWM_S2 is at an enable level, the first data writing transistor M3 and the first compensation transistor M4 are turned on, the second data signal PWM_DATA is written into the gate of the first driving transistor M1 through the turned on first data writing transistor M3 and first compensation transistor M4, and threshold compensation is performed. The second data signal PWM_DATA is related to the grayscale of the sub-pixel in the current frame. When displaying different grayscales, different second data signals PWM_DATA are provided to the sub-pixel. For example, different second data signals PWM_DATA are provided at a grayscale 0 and at a grayscale 255.

Then, the light emitting phase P2 is entered. In the light emitting phase P2, the second light emitting control signal PWM_EM is at an enable level, and the first light emitting control transistor M6 and the second light emitting control transistor M5 are turned on. The pulse width modulation module 10 can transmit the pulse width setting signal generated based on the second data signal PWM_DATA and the swept-frequency signal SWEEP to the first node N1.

The first light emitting control signal PAM_EM is at an enable level, and the third light emitting control transistor M11 and the fourth light emitting control transistor M12 are turned on.

It should be noted that the light emitting phase P2 is not a phase in which the light emitting element 12 effectively emits light, and the light emitting phase P2 includes an effective light emitting period and a non-light emitting period. The light emitting phase P2 can be understood as a phase in which the first light emitting control signal PAM_EM is an enable level.

In the light emitting phase P2, the first light emitting control signal PAM_EM controls the third light emitting control transistor M11 and the fourth light emitting control transistor M12 to be turned on, and the second driving transistor M7 generates a driving current under the control of the gate voltage thereof, so that the pulse amplitude modulation module 20 provides a driving current to the light emitting element 12. The driving current Id is calculated by Id=K3(V_{PAM_DATA}-V_{PAM_PVDD})², where V_{PAM_DATA} represents a voltage value of the first data signal PAM_DATA, V_{PAM_PVDD} represents a voltage value of the first power signal PAM_PVDD, and K3 represents a constant related to a characteristic of the second driving transistor M7.

The period in which the second light emitting control signal PWM_EM controls the first light emitting control transistor M6 and the second light emitting control transistor M5 to be turned on includes a signal change period, during which the swept-frequency signal SWEEP is a ramp signal that gradually changes from a high level to a low level. When the swept-frequency signal SWEEP changes, the voltage of the gate of the first driving transistor M1 starts to change from an initial gate voltage due to the coupling effect of the first capacitor C1. The initial gate voltage is the voltage of the gate of the first driving transistor M1 at an initial moment of a signal change period, and the initial gate voltage is related to the second data signal PWM_DATA. When the gate voltage of the first driving transistor M1 changes to a critical voltage Vg′, the Vg′ is calculated by Vg′=Vs-|Vth|, where Vs represents a source voltage of the first driving transistor M1, and Vs=V_{PWM_PVDD}. The first driving transistor M1 changes from an off state to an on state, and the second power signal PWM_PVDD as the pulse width setting signal is supplied to the first node N1 via the first driving transistor M1 and the first light emitting control transistor M6 that are turned on. As a result, the second driving transistor M7 is turned off, thereby stopping providing the driving current to the light emitting element 12. Different second data signals PWM_DATA lead to different initial gate voltages of the first driving transistors M1, accordingly, lead to different time required for the gate voltage of the first driving transistor M1 to change to the critical voltage Vg′, that is, the time when the first driving transistors M1 is in an off state correspondingly changes. FIG. 6 exemplarily illustrates a case that the first driving transistor M1 is turned on when a voltage value of the swept-frequency signal SWEEP changes to V1.

FIG. 6 shows a time point t3′, which is a time point at which the second driving transistor M7 is turned off, that is, the voltage value of the swept-frequency signal SWEEP changes to V1 at the time point t3′. Then, the time period between the turn-on time of the first light emitting control signal PAM_EM and the time point t3′ is an effective light emitting period t31 of the light emitting element 12.

Exemplarily, as shown in FIG. 6, in the data writing phase P1, the swept-frequency signal SWEEP is at a low level; in some time periods of the light emitting phase P2, for example, as shown in FIG. 6, in an initial time period of the light emitting phase P2, the swept-frequency signal SWEEP jumps from a low level to a high level, and then is decreased linearly from the high level, with a voltage value variation ΔV_{SWEEP}.

Exemplarily, as shown in FIG. 6, at least in the second data writing phase t22, that is, at least in a period in which the second pulse width scanning signal PWM_S2 is an enable signal, the swept-frequency signal SWEEP is at a low level. After the enable signal period of the second pulse width scanning signal PWM_S2 ends, the swept-frequency signal SWEEP jumps from a low level V2 to a high level V3, with a voltage value variation V3-V2=ΔV_{SWEEP}. In the light emitting phase P2, the swept-frequency signal SWEEP includes a signal change period. In the signal change period, the swept-frequency signal SWEEP is a ramp signal that gradually changes from the high level V3 to the low level V2. Since the swept-frequency signal SWEEP is connected to the gate of the first driving transistor M1 through the first capacitor C1, a gate potential of the first driving transistor M1 is raised in the process that the swept-frequency signal SWEEP jumps from a low level to a high level, and an gate voltage of the first driving transistor M1 is increased by ΔV_{SWEEP} after writing the second data signal PWM_DATA and performing the threshold compensation. That is, the initial gate voltage Vg1 is calculated by Vg1=V_{PWM_DATA}−|Vth|+ΔV_{SWEEP}, where V_{PWM_DATA} represents a voltage value of the second data signal PWM_DATA, and Vth represents a threshold voltage of the first driving transistor M1.

When the critical voltage Vg′ of the first driving transistor M1 remains unchanged, the swept-frequency signal SWEEP adopting the timing shown in FIG. 6 can reduce the voltage value of the second data signal PWM_DATA required when the gate voltage of the first driving transistor M1 reaches a target gate voltage. When the voltage value of the second data signal PWM_DATA remains unchanged, after data is written, the gate voltage of the first driving transistor M1 can be increased due to a signal jump of the swept-frequency signal SWEEP. When the swept-frequency signal SWEEP changes at a fixed rate, longer time can cause the gate potential of the first driving transistor M1 to drop from the initial gate voltage to the critical voltage Vg′. That is, in the light emitting phase P2, the time when the first driving transistor M1 is in an off state may be longer, and the corresponding time when the pulse amplitude modulation module 20 provides the driving current to the light emitting element 12 may be longer. Therefore, the swept-frequency signal SWEEP adopting a waveform design shown in FIG. 6 can improve a degree of freedom in regulating the flowing period of the driving current.

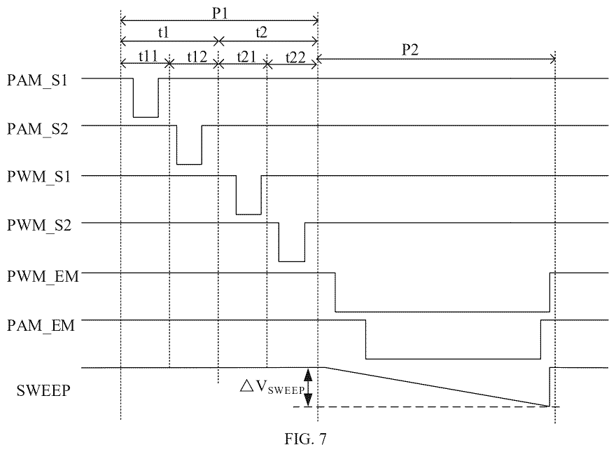

For example, as shown in FIG. 7, FIG. 7 is another operation timing diagram of the pixel driving circuit shown in FIG. 5, in the data writing phase P1, the swept-frequency signal SWEEP is at a high level; in a partial period of the light emitting phase P2, the swept-frequency signal SWEEP is decreased linearly from the high level, with the voltage value variation ΔV_{SWEEP}. In this case, the initial gate voltage Vg1 is calculated by Vg1=V_{PWM_DATA}−|Vth|.

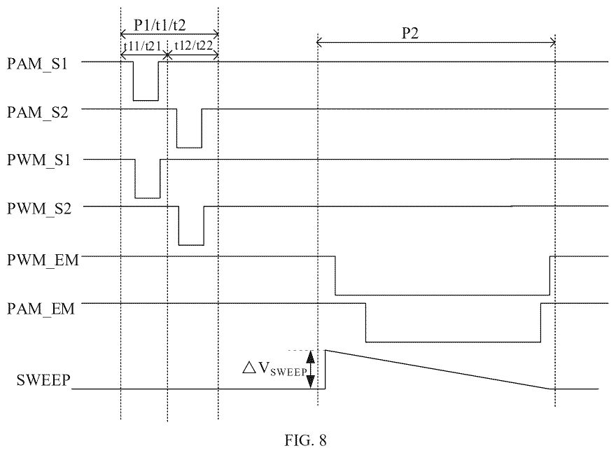

For example, an embodiment of the present disclosure further provides another timing diagram that can be used to drive the pixel driving circuit provided by an embodiment of FIG. 5, as shown in FIG. 8, which is another operation timing diagram of the pixel driving circuit shown in FIG. 5. The operation process of the pixel driving circuit 11 includes a writing phase P1 and a light emitting phase P2. The writing phase P1 can include a first writing phase t1 and a second writing phase t2. The first writing phase t1 includes a first gate reset phase t11 and a first data writing phase t12, and the second writing phase t2 includes a second gate reset phase t21 and a second data writing phase t22. The first gate reset phase t11 and the second gate reset phase t21 at least partially overlap each other, and the first data writing phase t12 and the second data writing phase t22 at least partially overlap each other.

In an embodiment of the present disclosure, as shown in FIG. 6, there is a time difference dt1 between a turn-on moment of the first light emitting control signal PAM_EM and a turn-on moment of the swept-frequency signal SWEEP. The turn-on moment of the swept-frequency signal SWEEP refers to the moment when the swept-frequency signal SWEEP starts to decrease.

For example, for at least two different sub-pixels, the time difference dt1 between the turn-on moment of the first light emitting control signal PAM_EM and the swept-frequency signal SWEEP for one of the at least two different sub-pixels is different from the time difference dt1 between the turn-on moment of the first light emitting control signal PAM_EM and the swept-frequency signal SWEEP for another one of the at least two different sub-pixels.

As shown in FIG. 6, assuming that when the swept-frequency signal SWEEP drops to V1, and V2≤V1≤V3, the first driving transistor M1 in the pulse width modulation module 10 is turned on, and the second power signal PWM_PVDD, which serves as the pulse width setting signal, is transmitted to the first node N1, to control the second driving transistor M7 to be turned off. As a result, the light emitting element 12 starts not to emit light. In addition, assuming that an initial potential of the swept-frequency signal SWEEP in the signal change period is V3, the duration of the signal change period is b, and the potential of the swept-frequency signal SWEEP at the end of the signal change period is V2, as shown in FIG. 6, after entering the signal change period, the swept-frequency signal SWEEP passes time dt1, that is, when the first light emitting control signal PAM_EM is turned on, the potential of the swept-frequency signal SWEEP changes from V3 to V3-dt1×k, where k is a slope of the swept-frequency signal SWEEP in the signal change period, and k=(V3-V2)/b. After continuing to pass time t31, the potential of the swept-frequency signal SWEEP changes from V3-dt1×k to V3-dt1×k-t31×k=V1, and the light emitting element 12 starts not to emit light. It can be derived that t31=(V3-V1)/k-dt1. Therefore, in an embodiment of the present disclosure, the effective light emitting time t31 of each of two sub-pixels can be configured differently by differentially configuring the time difference dt1 between the turn-on moment of the swept-frequency signal SWEEP and the turn-on moment of the first light emitting control signal that are provided to each of different sub-pixels, so that the brightness of each of the two sub-pixels can be adjusted by adjusting the effective light emitting time of each of the two sub-pixels, thereby improving the brightness uniformity of the display panel.

For example, in an embodiment of the present disclosure, the target grayscale can be determined jointly by the second data signal PWM_DATA and the swept-frequency signal SWEEP.

Exemplarily, in an embodiment of the present disclosure, at least two different sub-pixels having different effective light emitting time t31 can correspond to a same second data signal PWM_DATA, and/or correspond to a same swept-frequency signal SWEEP. Said “at least two different sub-pixels corresponding to a same swept-frequency signal SWEEP”, includes following cases: at least two different sub-pixels correspond to a swept-frequency signals SWEEP having a same waveform. In other words, at least two different sub-pixels correspond to a same turn-on moment of the swept-frequency signal SWEEP, that is, a same starting moment of the signal change period, and a same time length and a same slope of the swept-frequency signals SWEEP in the signal change period.

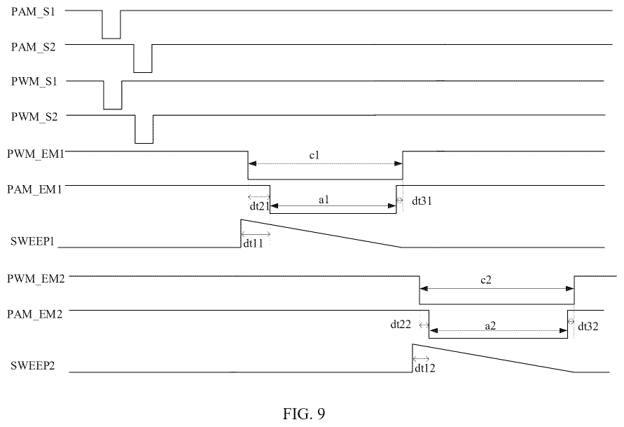

Exemplarily, as shown in FIG. 9, which is yet another operation timing diagram of two different sub-pixels in the display panel according to an embodiment of the present disclosure, the two sub-pixels are a first sub-pixel and a second sub-pixel, respectively, and the first sub-pixel and the second sub-pixel each may adopt the circuit structure shown in FIG. 5. In FIG. 9, SWEEP1 represents a swept-frequency signal provided to the first sub-pixel, PAM_EM1 represents a first light emitting control signal provided to the first sub-pixel, PWM_EM1 represents a second light emitting control signal provided to the first sub-pixel; SWEEP2 represents a swept-frequency signal provided to the second sub-pixel, PAM EM2 represents a first light emitting control signal provided to the second sub-pixel, and PWM_EM2 represents a second light emitting control signal provided to the second sub-pixel. As shown in FIG. 9, a time difference between the turn-on moment of the first light emitting control signal PAM_EM of the first sub-pixel and the turn-on moment of the swept-frequency signal SWEEP of the first sub-pixel is dt11, and a time difference between the turn-on moment of the first light emitting control signal PAM_EM of the second sub-pixel and the turn-on moment of the swept-frequency signal SWEEP of the second sub-pixel is dt12, where dt11/dt12, and FIG. 9 is illustrated by dt11>dt12 as an example.

Alternatively, for a same sub-pixel in at least two different states, the time difference between the turn-on moment of the first light emitting control signal PAM_EM and the swept-frequency signal SWEEP of the sub-pixel in one of the at least two different states is different from the time difference between the turn-on moment of the first light emitting control signal PAM_EM and the swept-frequency signal SWEEP of the sub-pixel in another one of the at least two different states, so that the sub-pixel in at least two different states have different effective light emitting time, to adjust the actual brightness of the sub-pixel in at least two different states to make the two tend to be consistent, thereby avoiding a possible flicker caused by a brightness difference.

For example, in some embodiments of the present disclosure, the turn-on moment of the swept-frequency signal SWEEP in each frame period has a same gap from the turn-on moment of the respective frame period, and a time gap from the turn-on moment of the first light emitting control signal PAM_EM of the first sub-pixel to the turn-on moment of the frame period is greater than a time gap from the turn-on moment of the first light emitting control signal PAM_EM of the second sub-pixel to the turn-on moment of the frame period.

For example, in an embodiment of the present disclosure, the swept-frequency signal SWEEP in each frame period has a same time duration and a same slope for the ramp signal. However, in some other optional embodiments of the present disclosure, the following designs of different time durations and different slopes of the ramp signals of the swept-frequency signals SWEEP can be combined, so that the swept-frequency signal SWEEP can be combined with the first light emitting control signal PAM_EM that varies, thereby jointly improving the display effect.

Exemplarily, as shown in FIG. 6, in an embodiment of the present disclosure, there is a time difference dt2 between the turn-on moment of the first light emitting control signal PAM_EM and the turn-on moment of the second light emitting control signal PWM_EM.

For example, for at least two different sub-pixels, the time difference dt2 between the turn-on moment of the first light emitting control signal PAM_EM and the second light emitting control signal PWM_EM of one of the at least two different sub-pixels is different from the time difference dt2 between the turn-on moment of the first light emitting control signal PAM_EM and the second light emitting control signal PWM_EM of another one of the at least two different sub-pixels. It can be seen from the description of the operation process of the pixel driving circuit that, in an embodiment of the present disclosure, the second light emitting control signal PWM_EM provided to the pulse width modulation module 10 can affect the time for the pulse width setting signal output by the pulse width modulation module 10 to be provided to the pulse amplitude modulation module 20. In the embodiment of the present disclosure, by differentially configuring the time difference dt2 between the turn-on moment of the first light emitting control signal PAM_EM and the turn-on moment of the second light emitting control signal PWM_EM of each of at least two different sub-pixels, the effective light emitting time of each of the two sub-pixels can be differentially configured, so that the brightness of each of the two sub-pixels can be adjusted by adjusting the effective light emitting time of each of the two sub-pixels, thereby improving the brightness uniformity of the display panel.

Exemplarily, as shown in FIG. 9, a time difference between the turn-on moment of the first light emitting control signal PAM_EM of the first sub-pixel and the turn-on moment of the second light emitting control signal PWM_EM of the first sub-pixel is dt21, and a time difference between the turn-on moment of the first light emitting control signal PAM_EM of the second sub-pixel and the turn-on moment of the second light emitting control signal PWM_EM of the second sub-pixel is dt22, where dt21/dt22, and FIG. 9 is illustrated by dt21>dt22 as an example.

For example, as shown in FIG. 9, a pulse width of an enable level of the first light emitting control signal PAM_EM of the first sub-pixel is a1, a pulse width of an enable level of the first light emitting control signal PAM_EM of the second sub-pixel is a2, a pulse width of an enable level of the second light emitting control signal PWM_EM of the first sub-pixel is c1, a pulse width of an enable level of the second light emitting control signal PWM_EM of the second sub-pixel is c2, a time difference between a turn-off moment of the first light emitting control signal PAM_EM of the first sub-pixel and a turn-off moment of the second light emitting control signal PWM_EM of the first sub-pixel is dt31, and a time difference between a turn-off moment of the first light emitting control signal PAM_EM of the second sub-pixel and a turn-off moment of the second light emitting control signal PWM_EM of the second sub-pixel is dt32. The turn-off moment refers to a moment at which a corresponding signal switches from an enable level to a non-enable level. In an embodiment of the present disclosure, c1=c2, and dt31=dt32. Based on such a configuration, when dt21/dt22, a1/a2, that is, the light emitting time of the first sub-pixel and the light emitting time of the second sub-pixel are configured differently.

Alternatively, in an embodiment of the present disclosure, for at least two different states of a same sub-pixel, the time difference between the turn-on moment of the first light emitting control signal PAM_EM and the second light emitting control signal PWM_EM of the sub-pixel in one of the at least two different states is different from the time difference between the turn-on moment of the first light emitting control signal PAM_EM and the second light emitting control signal PWM_EM of the sub-pixel in another one of the at least two different states, so that the sub-pixel has different effective light emitting time in at least two different states, thereby adjusting the brightness of the sub-pixel in at least two different states to tend to be consistent, and thus avoiding a possible flicker caused by the brightness difference.

In an embodiment of the present disclosure, for each of at least two different sub-pixels, the time difference between the turn-on moment of the first light emitting control signal PAM_EM and the turn-on moment of the second signal is different, so as to differentially configure the light emitting time of each of the two sub-pixels, so that the brightness of each of the two sub-pixels can be adjusted by adjusting the light emitting time of each of the two sub-pixels, thereby improving the brightness uniformity of the display panel. Alternatively, for a same sub-pixel in at least two different states, the time difference between the turn-on moment of the first light emitting control signal PAM_EM and the turn-on moment of the second signal is different in each of the at least two different states, so that the light emitting time of the sub-pixel is different in each of at least two different states, to adjust the brightness of the sub-pixel in each of at least two different states to tend to be consistent, thereby avoiding a possible flicker caused by the brightness difference. The second signal 2 includes the swept-frequency signal SWEEP and/or the second light emitting control signal PWM_EM.

Exemplarily, in an embodiment of the present disclosure, the turn-on moment of the swept-frequency signal SWEEP is not later than the turn-on moment of the first light emitting control signal PAM_EM. FIG. 6 and FIG. 9 illustrate an example that the turn-on moment of the swept-frequency signal SWEEP is earlier than the turn-on moment of the first light emitting control signal PAM_EM. Alternatively, the turn-on moment of the swept-frequency signal SWEEP and the turn-on moment of the signal of the first light emitting control signal PAM_EM can be simultaneously performed. Based on such a configuration, it can be ensured that when the first light emitting control signal PAM_EM is at an enable level to control the third light emitting control transistor M11 and the fourth light emitting control transistor M12 to be turned on, the swept-frequency signal SWEEP has been turned on. That is, the swept-frequency signal SWEEP has entered the signal change period, so that it can be ensured that when the first light emitting control signal PAM_EM is at an enable level to control the third light emitting control transistor M11 and the fourth light emitting control transistor M12 to be turned on, it can be determined whether the driving current generated by the second driving transistor M7 flows through the light emitting element 12 only by a conduction state of the second driving transistor M7. The conduction state of the second driving transistor M7 is affected by the pulse width setting signal output by the pulse width modulation module 10. Whether or not the pulse width setting signal is output is affected by the second light emitting control signal PWM_EM and the swept-frequency signal SWEEP. For example, when the second light emitting control signal PWM_EM is at an enable level to control the first light emitting control transistor M6 and the second light emitting control transistor M5 to be turned on, the pulse width modulation module 10 outputs a pulse width setting signal to the pulse amplitude modulation module 20.

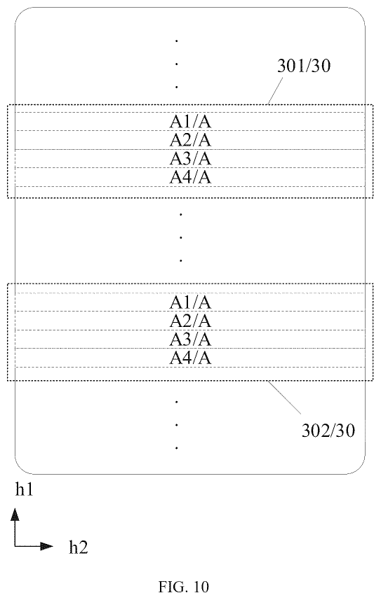

Exemplarily, as shown in FIG. 10, which is a schematic diagram of a display panel according to an embodiment of the present disclosure, the display panel includes a display region that includes display sub-regions, and the display sub-regions are provided with the sub-pixels described above. In an embodiment of the present disclosure, the sub-pixels in at least two different display sub-regions have the first time and the second time described above.

For example, the display sub-regions A at least include a first display sub-region A1 and a second display sub-region A2. In an embodiment of the present disclosure, the first display sub-region A1 has the first time, and the second display sub-region A2 has the second time. That is, the sub-pixel in the first display sub-region A1 has the first time, and the sub-pixel in the second display sub-region A2 has the second time. That is, the light emitting time of the sub-pixel in the first display sub-region A1 is different from the light emitting time of the sub-pixel in the second display sub-region A2. Alternatively, when the sub-pixel has the circuit structure shown in FIG. 5, the turn-on time of the first light emitting control signal PAM_EM of the sub-pixel in the first display sub-region A1 is different from the turn-on time of the first light emitting control signal PAM_EM of the sub-pixel in the second display sub-region A2.

In an embodiment of the present disclosure, the display sub-regions A can be divided according to light emitting time of different regions in the display panel. A plurality of sub-pixels in the same display sub-region A can emit light simultaneously, and sub-pixels located in different display sub-regions A can emit light during different time. As shown in FIG. 10, the display panel includes a first display sub-region A1, a second display sub-region A2, a third display sub-region A3 and a fourth display sub-region A4; and sub-pixels in the first display sub-region A1, the second display sub-region A2, the third display sub-region A3 and the fourth display sub-region A4 emit light during different time.

Exemplarily, in an embodiment of the present disclosure, as shown in FIG. 10, the display panel includes a plurality of display portions 30 repeatedly arranged along a first direction h1, and the display portion 30 includes the above-mentioned plurality of display sub-regions A that emit light during different time. As shown in FIG. 10, the display portions 30 at least include a first display portion 301 and a second display portion 302. The first display portion 301 includes a first display sub-region A1, a second display sub-region A2, a third display sub-region A3 and a fourth display sub-region A4; and the second display portion 302 includes a first display sub-region A1, a second display sub-region A2, a third display sub-region A3 and a fourth display sub-region A4. The first display sub-regions A1 can emit light simultaneously, the second display sub-regions A2 can emit light simultaneously, the third display sub-regions A3 can emit light simultaneously, and the fourth display sub-regions A3 can emit light simultaneously.

In the embodiments of the present disclosure, the display region of the display panel can be divided into a plurality of display sub-regions, and different display sub-regions are lit up in a time-sharing manner, thereby avoiding a problem of excessive voltage drop caused by excessive load on the first power signal line when all sub-pixels in the display panel are lit up at the same moment. The first power signal line is configured to transmit the first power signal PAM_PVDD. Based on such a configuration, the load on the first power signal line can be reduced, thereby reducing the voltage drop of the first power signal PAM_PVDD during the transmission process, and thus improving the display uniformity of the display panel.

Moreover, in an embodiment of the present disclosure, the sub-pixels in at least two different display sub-regions A have the first time and the second time. When driving the display panel, the brightness of the sub-pixels in the at least two different display sub-regions A tends to be consistent, thereby improving the brightness consistency of different regions of the display panel.

Exemplarily, in an embodiment of the present disclosure, the display region includes first display sub-regions and second display sub-regions, and at least one second display sub-region is arranged between two adjacent first display sub-regions. As shown in FIG. 10, two adjacent first display sub-regions A1 can be separated by a second display sub-region A2, a third display sub-region A3, and a fourth display sub-region A4; and two adjacent second display sub-regions A21 can be separated by a third display sub-region A3, a fourth display sub-region A4, and a first display sub-region A1. That is, the display sub-regions A that emit light simultaneously are separated by different display sub-regions A that emit light during different time. Based on such a configuration, the display sub-regions A that are emitting light are not concentrated in one region, but are distributed in at least two display portions 30, thereby further improving the uniformity of the display image.

For example, in an embodiment of the present disclosure, each display sub-region A may include a single pixel row, or include a plurality of pixel rows 3 adjacently arranged in the first direction h1.

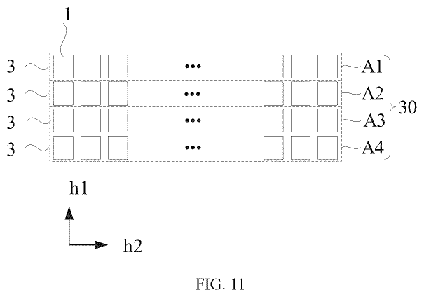

As shown in FIG. 11, which is a schematic diagram of a display portion according to an embodiment of the present disclosure, the display portion 30 includes a first display sub-region A1, a second display sub-region A2, a third display sub-region A3 and a fourth display sub-region A4, and each display sub-region includes a pixel row 3.

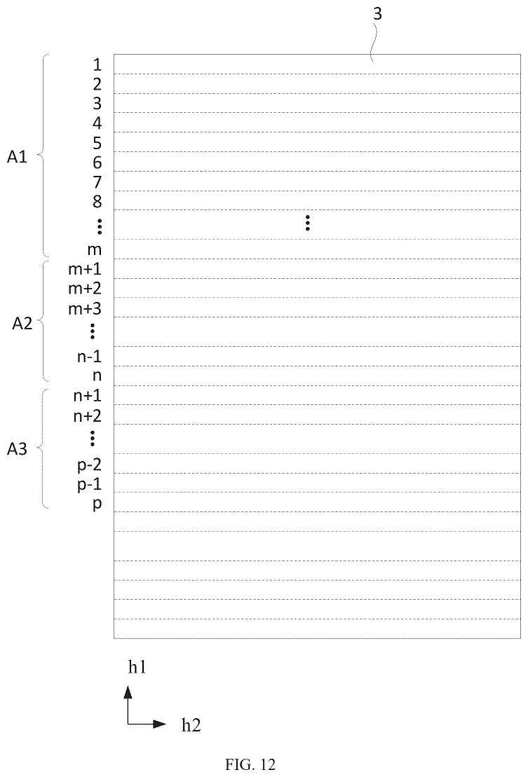

Alternatively, as shown in FIG. 12, FIG. 12 is a schematic diagram of another display panel according to an embodiment of the present disclosure, in an embodiment of the present disclosure, the first display sub-region A1 can include m pixel rows. For example, along a direction from top to bottom of the display panel, the first display sub-region A1 includes a first pixel row to an m-th pixel row, the second display sub-region A2 includes an (m+1)-th pixel row to an n-th pixel row, and the third display sub-region A3 includes an (n+1)-th pixel row to a p-th pixel row, where M is an integer greater than or equal to 1, n is an integer greater than or equal to m, and p is an integer greater than or equal to n.

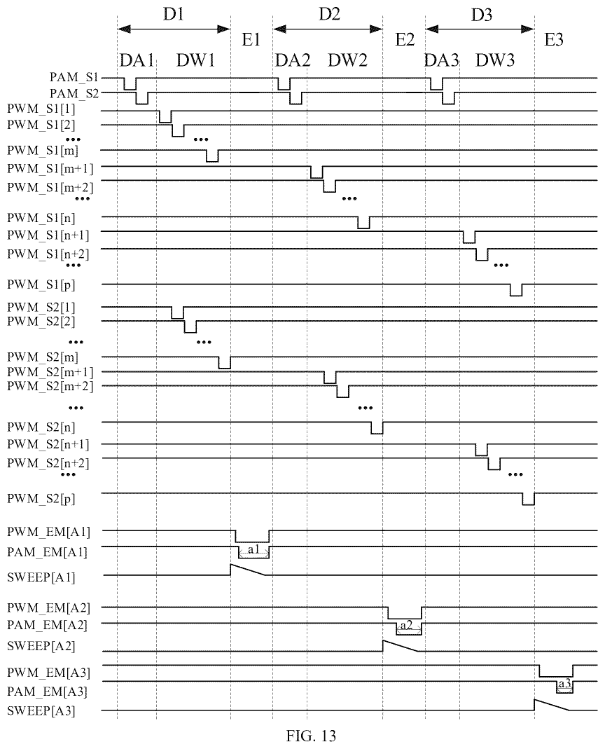

Exemplarily, with reference to FIG. 5 and FIG. 13, FIG. 13 is an operation timing diagram of a display panel according to an embodiment of the present disclosure, in an embodiment of the present disclosure, when driving the display panel, different pixel rows 3 can receive a same first pulse amplitude scanning signal PAM_S1, and different pixel rows 3 can receive a same second pulse amplitude scanning signal PAM_S2, so as to simplify the driving timing of the display panel and reduce a number of the first pulse amplitude scanning signal PAM_S1 and the second pulse amplitude scanning signal PAM_S2 required for the operation of the display panel.

For example, in an embodiment of the present disclosure, a plurality of pixel rows 3 in a same display sub-region A can receive a same swept-frequency signal SWEEP, a same second light emitting control signal PWM_EM, and a same first light emitting control signal PAM_EM, so that the plurality of pixel rows 3 in a same display sub-region A emit light simultaneously. Compared with a manner in which different pixel rows 3 receive different above-mentioned signals, the driving timing of the display panel can be simplified, and a number of the swept-frequency signal SWEEP, the second emitting control signal PWM_EM and the first light emitting control signal PAM_EM required for operation of the display panel can be reduced.

As shown in FIG. 13, when the display panel is displaying, a driving process of the display panel includes a first data writing phase D1 and a first light emitting phase E1 corresponding to the first display sub-region A1, a second data writing phase D2 and a second light emitting phase E2 corresponding to the second display sub-region A2, and a third data writing phase D3 and a third light emitting phase E3 corresponding to the third display sub-region A3.

The first data writing phase D1, the second data writing phase D2, and the third data writing phase D3 each include a first data signal writing phase DA and a second data signal writing phase DW. For distinguishing, in FIG. 13, the first data signal writing phase in the first data writing phase D1 is marked as DA1, the first data signal writing phase in the second data writing phase D2 is marked as DA2, and the first data signal writing phase in the third data writing phase D3 is marked as DA3; in addition, the second data signal writing phase in the first data writing phase D1 is marked as DW1, the second data signal writing phase in the second data writing phase D2 is marked as DW2, and the second data signal writing phase in the third data writing phase D3 is marked as DW3.

In the first data signal writing phase DA1, the first pulse amplitude scanning signal PAM_S1 and the second pulse amplitude scanning signal PAM_S2 are sequentially at an enable level. When the second pulse amplitude scanning signal PAM_S2 is at an enable level, the second data writing transistor M9 and the second compensation transistor M10 are turned on. The first data signal PAM_DATA is written into the gate of the second driving transistor M7 through the second data writing transistor M9 and the second compensation transistor M10, and threshold compensation is performed.

In the second data signal writing phase DW1, the first pulse width scanning signal PWM_S1 and the second pulse width scanning signal PWM_S2 in m sub-pixel rows in the first display sub-region A1 are at an enable level row by row. Then, the first light emitting phase E1 is entered. In the first light emitting phase E1, a second light emitting control signal PWM_EM[A1] and a first light emitting control signal PAM_EM[A1] in the first display sub-region A1 are at an enable level, and m sub-pixel rows in the first display sub-region A1 emit light. The duration of the driving current flowing through the sub-pixels is related to the written second data signal PWM_DATA and swept-frequency signal SWEEP.

Then, the second data writing phase D2, the second light emitting phase, the third data writing phase D3 and the third light emitting phase are sequentially performed for driving, and a driving process of each phase is similar to the corresponding phase of the first display sub-region A1.

In an embodiment of the present disclosure, as shown in FIG. 13, the first display sub-region A1 has first time a1, and the second display sub-region A2 has second time a2. The first time a1 is different from the second time a2. Based on such a configuration, different first time and second time can be used to compensate the brightness variation of the first display sub-region A1 and the second display sub-region A2 caused by different light emitting moments, as well as factors such as fluctuations in the driving signals and drifts of the threshold voltage characteristics of the driving transistors, thereby improving the brightness consistency of the first display sub-region A1 and the second display sub-region A2.

As shown in FIG. 13, in an example, the first time a1 is the light emitting time of the sub-pixel in the first display sub-region A1, and the second time a2 is the light emitting time of the sub-pixel in the second display sub-region A2, that is, the first time a1 is the pulse width of an enable level of the first light emitting control signal PAM_EM, and the second time a2 is the pulse width of an enable level of the first light emitting control signal PAM_EM. It is understandable that, in other examples, the first time may be the turn-on time of the first light emitting control signal PAM_EM of the sub-pixel in the first display sub-region A1, and the second time may be the turn-on time of the first light emitting control signal PAM_EM of the sub-pixel in the second display sub-region A2.

As shown in FIG. 13, the third display sub-region A3 includes third time a3. FIG. 13 shows an example that the third time a3 is the light emitting time of the sub-pixel in the third display sub-region A3, that is, the third time a3 is the pulse width of an enable level of the first light emitting control signal PAM_EM, and the third time a3 is different from each of the first time a1 and the second time a2.

In FIG. 13, the “i” in the first pulse width scanning signal PWM_S1[i] and the second pulse width scanning signal PWM_S2[i] represents a serial number of the pixel row where the pixel driving circuit is located. The first pulse width scanning signal PWM_S1[i] of the pixel driving circuit in the i-th row can be the same as the second pulse width scanning signal PWM_S2[i_1] of the pixel driving circuit in the (i_1)-th row.

The “j” in the swept-frequency signal SWEEP[j], the second light emitting control signal PWM_EM[j] and the first light emitting control signal PAM_EM[j] represents a serial number of the display sub-region where the pixel driving circuit is located. For example, the pixel driving circuit is located in the display sub-region A1, and the above-mentioned signal terminals of the pixel driving circuit are the swept-frequency signal SWEEP[A1], the second light emitting control signal PWM_EM[A1] and the first light emitting control signal PAM_EM[A1]. That is, pixel driving circuits in a display sub-region share a same swept-frequency signal SWEEP, a same second light emitting control signal PWM_EM, and a same first light emitting control signal PAM_EM, so that the sub-pixels in a same display sub-region emit light simultaneously.

Exemplarily, the sub-pixel further receives a second signal. In an embodiment of the present disclosure, in at least one display sub-region, for at least two different sub-pixels, the time difference between a turn-on moment of the first light emitting control signal PAM_EM and a turn-on moment of the second signal of one of the at least two different sub-pixels is the same as the time difference between a turn-on moment of the first light emitting control signal PAM_EM and a turn-on moment of the second signal of another one of the at least two different sub-pixels. When the second signal includes the swept-frequency signal SWEEP and/or the second light emitting control signal PWM_EM, as shown in FIG. 13, in the first display sub-region A1, the first light emitting control signal PAM_EM of each sub-pixel has a same turn-on moment, and the second signal of each sub-pixel has a same turn-on moment, so that the time difference between the two is also the same. In the second display sub-region A2, the first light emitting control signal PAM_EM of each sub-pixel has a same turn-on moment, and the second signal of each sub-pixel has a same turn-on moment, so that the time difference between the two is also the same. In the third display sub-region A3, the first light emitting control signal PAM_EM of each sub-pixel has a same turn-on moment, and the second signal of each sub-pixel has a same turn-on moment, so that the time difference between the two is also the same. Based on such a configuration, while achieving the display uniformity of different display sub-regions, the sub-pixels in a same display sub-region can receive a same first light emitting control signal PAM_EM and a same second signal, thereby being beneficial to simplifying the driving timing of the display panel.

In an embodiment of the present disclosure, as shown in FIG. 13, the first display sub-region A1 and the second display sub-region A2 receive different swept-frequency signals SWEEP. Under the action of different swept-frequency signals SWEEP, the sub-pixels in the first display sub-region A1 and the second display sub-region A2 may have different light emitting time, thereby improving the brightness consistency of the sub-pixels in the first display sub-region A1 and the second display sub-region A2.

Exemplarily, the sub-pixels in a same display sub-region share a same swept-frequency signal SWEEP, to achieve the brightness uniformity of different display sub-regions while reducing the number of swept-frequency signals SWEEP required for the display panel to operate, thereby reducing the driving complexity of the display panel.

Exemplarily, as shown in FIG. 6, the swept-frequency signal SWEEP includes a signal change period ΔT, and the swept-frequency signal SWEEP has a change rate in the signal change period ΔT.

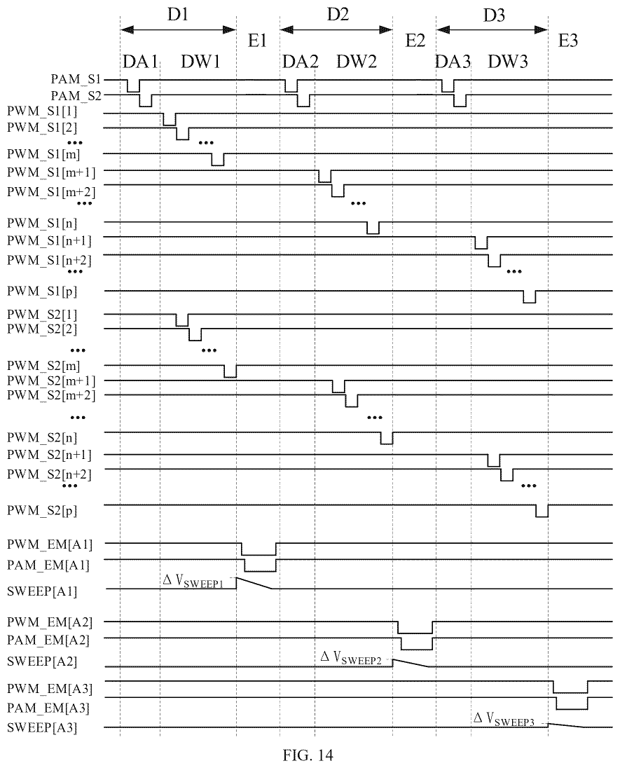

In an embodiment of the present disclosure, the swept-frequency signal SWEEP includes a first swept-frequency signal SWEEP[A1] and a second swept-frequency signal SWEEP[A2]. The first display sub-region A1 receives the first swept-frequency signal SWEEP[A1], and the second display sub-region A2 receives the second swept-frequency signal SWEEP[A2]. As shown in FIG. 14, FIG. 14 is an operation timing diagram of another display panel according to an embodiment of the present disclosure, a change rate of the first swept-frequency signal SWEEP[A1] in the signal change period is different from a change rate of the second swept-frequency signal SWEEP[A2] in the signal change period.

In an embodiment of the present disclosure, with reference to the equation t31=(V3-V1)/k-dt1, it can be seen that, the effective light emitting time t31 of the sub-pixels in different display sub-regions can be configured differentially by differentially configuring a slope k of the swept-frequency signal SWEEP provided to each of different display sub-regions, so that the brightness of the sub-pixels in different display sub-regions can be adjusted by adjusting the effective light emitting time in different display sub-regions.

As shown in FIG. 14, the third display sub-region A3 receives a third swept-frequency signal SWEEP[A3], and a change rate of the third swept-frequency signal SWEEP[A3] in the signal change period is different from each of the change rate of the first swept-frequency signal SWEEP[A1] and the change rate of the second swept-frequency signal SWEEP[A2] in the signal change period. FIG. 14 shows an example that the change rate of the first swept-frequency signal SWEEP[A1] in the signal change period is greater than the change rate of the second swept-frequency signal SWEEP[A2] in the signal change period, and the change rate of the second swept-frequency signal SWEEP[A2] in the signal change period is greater than the change rate of the third swept-frequency signal SWEEP[A3] in the signal change period.

Exemplarily, as shown in FIG. 6, the swept-frequency signal SWEEP has a value difference ΔV_{SWEEP} between the maximum value and the minimum value in the signal change period, where ΔV_{SWEEP}=V3-V2. In an embodiment of the present disclosure, as shown in FIG. 14, the value difference of the first swept-frequency signal SWEEP[A1] is different from the value difference of the second swept-frequency signal SWEEP[A2]. As shown in FIG. 14, the first swept-frequency signal SWEEP[A1] has a first value difference ΔV_{SWEEP1} in the signal change period, and the second swept-frequency signal SWEEP[A2] has a second value difference ΔV_{SWEEP2} in the signal change period. The first value difference ΔV_{SWEEP1} is different from the second value difference ΔV_{SWEEP2}.

In an embodiment of the present disclosure, with reference to the equations t31=(V3-V1)/k-dt1 and k=(V3-V2)/b=ΔV_{SWEEP}/b, it can be seen that, the effective light emitting time t31 of the sub-pixels in different display sub-regions can be configured differentially by differentially configuring the value difference ΔV_{SWEEP} of the swept-frequency signal SWEEP provided to each of different display sub-regions, so that the brightness of the sub-pixels in different display sub-regions can be adjusted by adjusting the effective light emitting time in different display sub-regions.

As shown in FIG. 14, the third display sub-region A3 receives the third swept-frequency signal SWEEP[A3], and the third swept-frequency signal SWEEP[A3] has a third value difference ΔV_{SWEEP3} in the signal change period. The third value difference ΔV_{SWEEP3} is different from beach of the first value difference ΔV_{SWEEP1} and the second value difference ΔV_{SWEEP2}. FIG. 14 shows an example that the first value difference ΔV_{SWEEP1} is greater than the second value difference ΔV_{SWEEP2}, and the second value difference ΔV_{SWEEP2} is greater than the third value difference ΔV_{SWEEP3}.

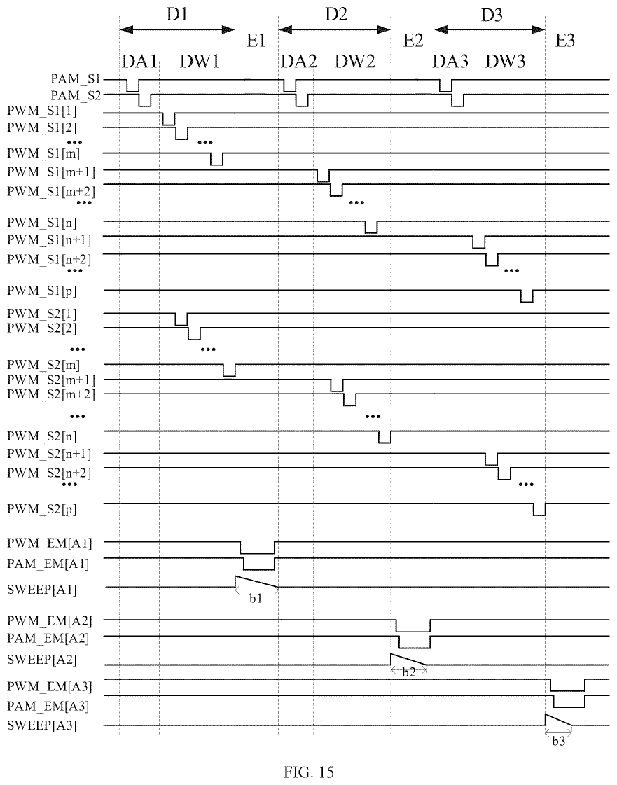

Exemplarily, in an embodiment of the present disclosure, as shown in FIG. 15, FIG. 15 is an operation timing diagram of another display panel according to an embodiment of the present disclosure, a duration of the first swept-frequency signal SWEEP[A1] in the signal change period is different from a duration of the second swept-frequency signal SWEEP[A2] in the signal change period. As shown in FIG. 15, the duration of the first swept-frequency signal SWEEP[A1] in the signal change period is a first duration b1, and the duration of the second swept-frequency signal SWEEP[A2] in the signal change period is a second duration b2. The first duration b1 is different from the second duration b2.

In an embodiment of the present disclosure, with reference to the equations t31=(V3-V1)/k-dt1 and k=(V3-V2)/b, it can be seen that, the effective light emitting time t31 of the sub-pixels in different display sub-regions can configured differentially by differentially configuring the duration b of the swept-frequency signal SWEEP provided to each of different display sub-regions in the signal change period, so that the brightness of the sub-pixels in different display sub-regions can be adjusted by adjusting the effective light emitting time in different display sub-regions.

As shown in FIG. 15, the third display sub-region A3 receives the third swept-frequency signal SWEEP[A3], and a duration of the third swept-frequency signal SWEEP[A3] in the signal change period is a third duration b3. The third duration b3 is different from each of the first duration b1 and the second duration b2. FIG. 15 shows an example that the first duration b1 is greater than the second duration b2, and the second duration b2 is greater than the third duration b3.

Exemplarily, in an embodiment of the present disclosure, for any two adjacent display sub-regions, the time difference between a turn-on moment of the swept-frequency signal SWEEP and a turn-on moment of the first light emitting control signal PAM_EM of one of the two adjacent display sub-regions is different from the time difference between a turn-on moment of the swept-frequency signal SWEEP and a turn-on moment of the first light emitting control signal PAM_EM of the other one of the two adjacent display sub-regions. Based on such a configuration, different display sub-regions A can adjust the time difference between the turn-on moment of the received swept-frequency signal SWEEP and the turn-on moment of the first light emitting control signal PAM_EM according to the difference of the respective light emitting moments, so that the light emitting time of any two adjacent display sub-regions is matched with the light emitting moments of the display sub-regions A, thereby adjusting the actual brightness of each display sub-region A more finely, and further improving the display consistency of the display panel.

For example, in an embodiment of the present disclosure, for any two display sub-regions A, the time difference between a turn-on moment of the swept-frequency signal SWEEP and a turn-on moment of the first light emitting control signal PAM_EM in one of the two display sub-regions A can be different from the time difference between a turn-on moment of the swept-frequency signal SWEEP and a turn-on moment of the first light emitting control signal PAM_EM in the other one of the two display sub-regions A, to adjust the display uniformity of different display sub-regions A.

Exemplarily, the time difference between the turn-on moment of the swept-frequency signal SWEEP and the turn-on moment of the first light emitting control signal PAM_EM in each of different display sub-regions can gradually increase or gradually decrease according to a scanning sequence of the display sub-regions. The scanning sequence is a time sequence in which the above-mentioned data writing phase is executed. For example, in FIG. 13, the display sub-regions are scanned in a sequence of the first display sub-region A1, the second display sub-region A2 and the third display sub-region A3. Therefore, in an embodiment of the present disclosure, the time difference between the turn-on moment of the swept-frequency signal SWEEP and the turn-on moment of the first light emitting control signal PAM_EM that are received by each of the first display sub-region A1, the second display sub-region A2 and the third display sub-region A3 can gradually increase or gradually decrease in sequence. Based on such a configuration, the influence of different scanning sequences on the actual brightness of each display sub-region A can be compensated, thereby further improving the display uniformity of the display panel.

For example, for any two adjacent display sub-regions, the time difference between a turn-on moment of the second light emitting control signal PWM_EM and a turn-on moment of the first light emitting control signal PAM_EM in one of the two adjacent display sub-regions is different from the time difference between a turn-on moment of the second light emitting control signal PWM_EM and a turn-on moment of the first light emitting control signal PAM_EM in the other one of the two adjacent display sub-regions. Based on such a configuration, the time difference between the turn-on moment of the second light emitting control signal PWM_EM and the turn-on moment of the first light emitting control signal PAM_EM that are received by each of any two adjacent display sub-regions can be adjusted according to a respective different light emitting moment thereof, so that the light emitting time of each of the any two adjacent display sub-regions can be matched with the respective light emitting moment, thereby adjusting the actual brightness of each display sub-region A more finely, and further improving the display consistency of the display panel.

Exemplarily, in an embodiment of the present disclosure, for any two display sub-regions, the time difference between the turn-on moment of the second light emitting control signal PWM_EM and the turn-on moment of the first light emitting control signal PAM_EM in one of the two display sub-regions can be different from the time difference between the turn-on moment of the second light emitting control signal PWM_EM and the turn-on moment of the first light emitting control signal PAM_EM in the other one of the two display sub-regions, so as to adjust the display uniformity of different display sub-regions A.

For example, according to a scanning sequence of the display sub-regions, the time difference dt2 between the turn-on moment of the second light emitting control signal PWM_EM and the turn-on moment of the first light emitting control signal PAM_EM in each of different display sub-regions can be gradually increased or gradually decreased. For example, in FIG. 10, the display sub-regions are scanned in a sequence of the first display sub-region A1, the second display sub-region A2 and the third display sub-region A3. Therefore, in an embodiment of the present disclosure, the time difference between the turn-on moment of the second light emitting control signal PWM_EM and the turn-on moment of the first light emitting control signal PAM_EM that are received by each of the first display sub-region A1, the second display sub-region A2 and the third display sub-region A3 can be gradually increased or gradually decreased. Based on such a configuration, the influence of different scanning sequences on the actual brightness of each display sub-region can be compensated, thereby further improving the display uniformity of the display panel.

Exemplarily, in an embodiment of the present disclosure, when driving the display panel, the brightness of at least two different sub-pixels can be compared first. The brightness is the actual brightness of the sub-pixel. The actual brightness can be detected by a brightness detection instrument. In an embodiment of the present disclosure, when the brightness of one of the sub-pixels is smaller than the brightness of another one of the sub-pixels, the first time of one of the sub-pixels can be greater than the second time of another one of the sub-pixels, so as to increase the light emitting time of one of the sub-pixels and decrease the light emitting time of another one of the sub-pixels, thereby reducing the actual brightness difference between the two sub-pixels after adjustment. For example, the actual brightness of the two sub-pixels after adjustment is the same, thereby improving the display uniformity of the display panel.

For example, the display panel includes the first display sub-region A1 and the second display sub-region A2. In an embodiment of the present disclosure, when driving the display panel, the initial brightness of the sub-pixels in the first display sub-region A1 and the second display sub-region A2 can be compared first. In an embodiment of the present disclosure, when the initial brightness of the sub-pixel in the first display sub-region A1 is smaller than the initial brightness of the sub-pixel in the second display sub-region A2, the first time corresponding to the first display sub-region A1 can be adjusted to be greater than the second time corresponding to the second display sub-region A2, thereby reducing the actual brightness difference between the sub-pixels in the first display sub-region A1 and the second display sub-region A2 after adjustment.

Exemplarily, in an embodiment of the present disclosure, at least two different sub-pixels have a same target brightness. The target brightness is an ideal brightness that the sub-pixel in each of the two regions is expected to achieve. When the sub-pixels in two different regions have a same target brightness, the influence of factors such as different light emitting moments or threshold voltage drifts on the actual brightness of the sub-pixels in the two different regions can be compensated in the above-described manner, and the difference in the actual brightness of the sub-pixels in the two different regions can be reduced, thereby improving the display effect and avoiding the display non-uniformity.

For example, in an embodiment of the present disclosure, the brightness of the same sub-pixel in different states can be compared. When the brightness of a sub-pixel in one state is smaller than the brightness of the sub-pixel in another one state, the first time of the sub-pixel in one state is greater than second time of the sub-pixel in another one state, to reduce the difference between actual brightness of the sub-pixels in two different states.

Exemplarily, in an embodiment of the present disclosure, a same sub-pixel has a same target brightness in different states. The target brightness is an ideal brightness that the sub-pixel is expected to achieve in two states. When the sub-pixel has a same target brightness in different states, the influence of factors such as different light emitting moments or threshold voltage drifts on the actual light emitting brightness can be compensated in the above-described manner, and the difference in the actual brightness of the sub-pixel in two different states can be reduced, thereby improving the display effect and avoiding the display non-uniformity.

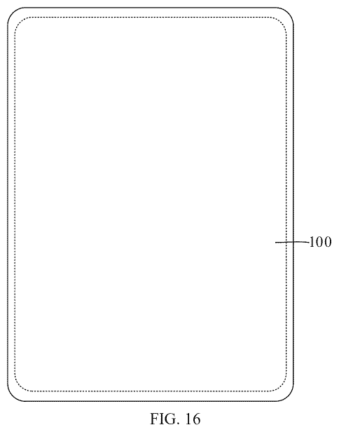

Based on the same inventive concept, an embodiment of the present disclosure further provides a display device, as shown in FIG. 16, which is a schematic diagram of a display device according to an embodiment of the present disclosure, the display device includes the above-mentioned display panel 100. The specific structure of the display panel 100 has been described in detail in the foregoing embodiments, and details are not described herein again. It is understandable that the display device shown in FIG. 16 is merely illustrative, and the display device can be any electronic device having a display function such as a mobile phone, a vehicle-mounted display screen, a tablet computer, a notebook computer, an electronic paper book, or a television.

Based on the same inventive concept, an embodiment of the present disclosure further provides a driving method of a display panel, applied to the above-mentioned display panel, and the driving method includes: controlling the display panel to at least have first time and second time that are different from each other.

The first time and the second time are light emitting time of different sub-pixels.

Alternatively, the first time and the second time are turn-on time of the first light emitting control signals of different sub-pixels.

Alternatively, the first time and the second time are light emitting time of a same sub-pixel in different states.

Alternatively, the first time and the second time are turn-on time of the first light emitting control signal of a same sub-pixel in different states.

In an embodiment of the present disclosure, when the first time and the second time are the light emitting time of different sub-pixels in the display panel, or are the turn-on time of the first light emitting control signals of different sub-pixels in the display panel, a brightness difference caused by factors such as different light emitting moments or different threshold voltage drifts of different sub-pixels can be compensated by making the first time and the second time different from each other, thereby improving display consistency of different regions of the display panel.

In an embodiment of the present disclosure, when the first time and the second time are the light emitting time of a same sub-pixel in different states, or the first time and the second time are the turn-on time of the first light emitting control signal of a same sub-pixel in different states, the first time and the second time are different from each other, thereby avoiding a possible flicker caused by different brightness of the display panel at different moments.

For example, the driving method of the display panel further includes: comparing the brightness of at least two different sub-pixels; and upon determining that the brightness of one of the sub-pixels is smaller than the brightness of another one of the sub-pixels, controlling the first time of one of the sub-pixels to be greater than the second time of another one of the sub-pixels, so as to increase the light emitting time of one of the sub-pixels and decrease the light emitting time of another one of the sub-pixels, thereby reducing the actual brightness difference between the two sub-pixels after adjustment. For example, the actual brightness of the two sub-pixels after adjustment is the same, thereby improving the display uniformity of the display panel.

Exemplarily, at least two different sub-pixels include a first sub-pixel and a second sub-pixel, and the brightness of the first sub-pixel is smaller than the brightness of the second sub-pixel. As shown in FIG. 9, in an embodiment of the present disclosure, the pulse width of an enable level of the first light emitting control signal PAM_EM of the first sub-pixel can be smaller than the pulse width of an enable level of the first light emitting control signal PAM_EM of the second sub-pixel, that is, a1<a2.

For example, as shown in FIG. 9, in an embodiment of the present disclosure, the time difference between the turn-on moment of the first light emitting control signal PAM_EM of the first sub-pixel and the turn-on moment of the second light emitting control signal PWM_EM of the first sub-pixel can be greater than the time difference between the turn-on moment of the first light emitting control signal PAM_EM of the second sub-pixel and the turn-on moment of the second light emitting control signal PWM_EM of the second sub-pixel, that is, dt21>dt22; the pulse width of an enable level of the second light emitting control signal PWM_EM of the first sub-pixel is equal to the pulse width of an enable level of the second light emitting control signal PWM_EM of the second sub-pixel, that is, c1=c2; and the time difference between the turn-off moment of the first light emitting control signal PAM_EM of the first sub-pixel and the turn-off moment of the second light emitting control signal PWM_EM of the first sub-pixel is equal to the time difference between the turn-off moment of the first light emitting control signal PAM_EM of the second sub-pixel and the turn-off moment of the second light emitting control signal PWM_EM of the second sub-pixel, that is, dt31=dt32. As a result, a1<a2.

Exemplarily, in an embodiment of the present disclosure, at least two different sub-pixels have a same target brightness. The target brightness is an ideal brightness that each of the sub-pixels in the two regions is expected to achieve. When two different sub-pixels have a same target brightness, the influence of factors such as different light emitting moments or threshold voltage drifts on the actual light emitting brightness can be compensated in the above-described manner, and the difference in the actual brightness of the two different sub-pixels is reduced, thereby improving the display effect and avoiding the display non-uniformity.

Exemplarily, the driving method of the display panel further includes: comparing brightness of a same sub-pixel in different states. When the brightness of a sub-pixel in a state is smaller than the brightness of the sub-pixel in another state, first time of the sub-pixel in a state is greater than second time of the sub-pixel in another state, so that the actual brightness difference between the two is reduced.

For example, in an embodiment of the present disclosure, a same sub-pixel has a same target brightness in different states. The target brightness is an ideal brightness that the sub-pixel is expected to achieve in two periods. When the sub-pixel in two different states has a same in two different states, the influence of factors such as different light emitting moments or threshold voltage drifts on the actual light emitting brightness can be compensated in the above-described manner, and the difference of the actual brightness of the sub-pixel in the two states is reduced, thereby improving the display effect and avoiding the display abnormality such as flicker.

The above description merely illustrates some preferred embodiments of the present disclosure and is not intended to limit the present disclosure, and any modification, equivalent substitution, improvement and the like made within a spirit and a principle of the present disclosure shall fall with a scope of the present disclosure.

Finally, it should be noted that, the above-described embodiments are merely for illustrating the present disclosure but not intended to provide any limitation. Although the present disclosure has been described in detail with reference to the above-described embodiments, it should be understood by those skilled in the art that, it is still possible to modify the technical solutions described in the above embodiments or to equivalently replace some or all of the technical features therein, but these modifications or replacements do not cause the essence of corresponding technical solutions to depart from the scope of the present disclosure.

What is claimed is:

1. A display panel, comprising sub-pixels, wherein
one of the sub-pixels receives a first light emitting control signal;
the display panel is characterized by at least a first time and a second time that are different from each other; and
the first time and the second time are light emitting times of different sub-pixels, or the first time and the second time are turn-on times of the first light emitting control signals of different sub-pixels, or the first time and the second time are light emitting times of a same sub-pixel in different states, or the first time and the second time are turn-on times of the first light emitting control signal of a same sub-pixel in different states.

2. The display panel according to claim 1, wherein
at a same target grayscale, the first time is different from the second time.

3. The display panel according to claim 1, wherein
one of the sub-pixels further receives a second signal; and
for at least two different sub-pixels, a time difference between a turn-on moment of the first light emitting control signal and a turn-on moment of the second signal of one of the at least two different sub-pixels is different from a time difference between a turn-on moment of the first light emitting control signal and a turn-on moment of the second signal of another one of the at least two different sub-pixels; or for a same sub-pixel in different states, a time difference between a turn-on moment of the first light emitting control signal and a turn-on moment of the second signal of the sub-pixel in one of the at least two different states is different from a time difference between a turn-on moment of the first light emitting control signal and a turn-on moment of the second signal of the sub-pixel in another one of the at least two different states.

4. The display panel according to claim 3, wherein
one of the sub-pixels comprises a pulse width modulation module corresponding to the second signal, and a pulse amplitude modulation module corresponding to the first light emitting control signal.

5. The display panel according to claim 4, wherein
one of the sub-pixels comprises a pixel driving circuit and a light emitting element that are electrically connected to each other;
the pixel driving circuit comprises a second driving transistor, the pulse width modulation module and the pulse amplitude modulation module;
the second driving transistor is configured to output a driving current in response to a signal of a gate of the second driving transistor and a signal of a first terminal of the second driving transistor;
the pulse width modulation module is configured to output a pulse width setting signal to a first terminal of the pulse amplitude modulation module based on a swept-frequency signal and a second light emitting control signal, to control light emitting time of the light emitting element; and
the pulse amplitude modulation module is configured to control the light emitting element to emit light in response to the driving current under the control of the first light emitting control signal.

6. The display panel according to claim 5, wherein
the second signal comprises the swept-frequency signal.

7. The display panel according to claim 6, wherein
a turn-on moment of the swept-frequency signal is not later than a turn-on moment of the first light emitting control signal.

8. The display panel according to claim 6, wherein
an operation process of the sub-pixel comprises a data writing phase and a light emitting phase, and
in the data writing phase, the swept-frequency signal is at a high level; and in part of the light emitting phase, the swept-frequency signal is decreased linearly from the high level.

9. The display panel according to claim 6, wherein
an operation process of the sub-pixel comprises a data writing phase and a light emitting phase, and
in the data writing phase, the swept-frequency signal is at a low level; and in part of the light emitting phase, the swept-frequency signal jumps from the low level to a high level, and then is decreased linearly from the high level.

10. The display panel according to claim 5, wherein
the second signal comprises the second light emitting control signal.

11. The display panel according to claim 1, wherein
the display panel comprises display sub-regions that at least comprise a first display sub-region and a second display sub-region, and the first display sub-region has the first time and the second display sub-region has the second time.

12. The display panel according to claim 11, wherein
one of the sub-pixel further receives a second signal; and
in at least one of the display sub-regions, for at least two different sub-pixels, a time difference between a turn-on moment of the first light emitting control signal and a turn-on moment of the second signal of one of the at least two different sub-pixels is the same as a time difference between a turn-on moment of the first light emitting control signal and a turn-on moment of the second signal of another one of the at least two different sub-pixels.

13. The display panel according to claim 11, wherein
one of the sub-pixels comprises a pixel driving circuit and a light emitting element that are electrically connected to each other;
the pixel driving circuit comprises a pulse width modulation module, a pulse amplitude modulation module and a driving transistor,
the pulse width modulation module is configured to output a pulse width setting signal to a first terminal of the pulse amplitude modulation module based on a swept-frequency signal and a second light emitting control signal;
the driving transistor is configured to output a driving current in response to a signal of a gate of the driving transistor and a signal of a first terminal of the driving transistor;
the pulse amplitude modulation module is configured to control the light emitting element to emit light in response to the driving current under the control of the first light emitting control signal, and output the pulse width setting signal to the gate of the driving transistor to control light emitting time of the light emitting element; and
the first display sub-region and the second display sub-region receive different swept-frequency signals.

14. The display panel according to claim 13, wherein
the sub-pixels in a same one of the display sub-regions share a same swept-frequency signal.

15. The display panel according to claim 13, wherein
the swept-frequency signals comprise a first swept-frequency signal and a second swept-frequency signal, the first display sub-region receives the first swept-frequency signal, and the second display sub-region receives the second swept-frequency signal; and
the swept-frequency signal comprises a signal change period, and a change rate of the first swept-frequency signal in the signal change period is different from a change rate of the second swept-frequency signal in the signal change period.

16. The display panel according to claim 15, wherein
the swept-frequency signal has a value difference between a maximum value and a minimum value in the signal change period; and
the value difference of the first swept-frequency signal is different from the value difference of the second swept-frequency signal.

17. The display panel according to claim 15, wherein
a duration of the first swept-frequency signal in the signal change period is different from a duration of the second swept-frequency signal in the signal change period.

18. The display panel according to claim 13, wherein
the display panel comprises first display sub-regions and second display sub-regions, and at least one second display sub-region is arranged between two adjacent first display sub-regions.

19. The display panel according to claim 13, wherein
each of any two adjacent display sub-regions has a respective different time difference between a turn-on moment of the swept-frequency signal and a turn-on moment of the first light emitting control signal.

20. The display panel according to claim 19, wherein
in different display sub-regions, the time difference between the turn-on moment of the swept-frequency signal and the turn-on moment of the first light emitting control signal gradually increases or gradually decreases according to a scanning sequence of the display sub-regions.

21. The display panel according to claim 13, wherein
each of any two adjacent display sub-regions has a respective different time difference between a turn-on moment of the second light emitting control signal and a turn-on moment of the first light emitting control signal.

22. The display panel according to claim 21, wherein
in different display sub-regions, the time difference between the turn-on moment of the second light emitting control signal and the turn-on moment of the first light emitting control signal gradually increases or gradually decreases according to a scanning sequence of the display sub-regions.

23. The display panel according to claim 1, wherein
a brightness of one of at least two different sub-pixels is compared with a brightness of another one of the at least two different sub-pixels; and
upon determining that the brightness of one of the at least two sub-pixels is smaller than the brightness of another one of the at least two sub-pixels, the first time of one of the at least two sub-pixels is greater than the second time of another one of the at least two sub-pixels.

24. The display panel according to claim 23, wherein at least two different sub-pixels have a same target brightness.

25. The display panel according to claim 1, wherein
a brightness of a sub-pixel in one of at least two different states is compared with a brightness of the sub-pixel in another one of the at least two different states; and
upon determining that the brightness of the brightness of the sub-pixel in one of the at least two different states is smaller than the brightness of the sub-pixel in another one of the at least two different states, the first time of the sub-pixel in one of the at least two different states is greater than the second time of the sub-pixel in another one of the at least two different states.

26. The display panel according to claim 25, wherein a same sub-pixel in different states has a same target brightness.

27. A display device, comprising a display pane that comprise sub-pixels, wherein
one of the sub-pixels receives a first light emitting control signal;
the display panel is characterized by at least a first time and a second time that are different from each other; and
the first time and the second time are light emitting times of different sub-pixels, or the first time and the second time are turn-on times of the first light emitting control signals of different sub-pixels, or the first time and the second time are light emitting times of a same sub-pixel in different states, or the first time and the second time are turn-on times of the first light emitting control signal of a same sub-pixel in different states.

28. A driving method of a display panel, wherein the display panel comprises sub-pixels, wherein
one of the sub-pixels receives a first light emitting control signal;
the display panel is characterized by a first time and a second time that are different from each other; and
the first time and the second time are light emitting times of different sub-pixels, or the first time and the second time are turn-on times of the first light emitting control signals of different sub-pixels, or the first time and the second time are light emitting times of a same sub-pixel in different states, or the first time and the second time are turn-on times of the first light emitting control signal of a same sub-pixel in different states;
wherein the driving method comprises: controlling the display panel to at least have the first time and the second time.

29. The driving method according to claim 28, comprises:
comparing a brightness of one of at least two different sub-pixels with a brightness of another one of the at least two different sub-pixels; and
upon determining that the brightness of one of the at least two sub-pixels is smaller than the brightness of another one of the at least two sub-pixels, controlling the first time of one of the at least two sub-pixels to be greater than the second time of another one of the at least two sub-pixels.

30. The driving method according to claim 29, wherein at least two different sub-pixels have a same target brightness.

31. The driving method according to claim 28, comprises:
comparing a brightness of a sub-pixel in one of at least two different states with a brightness of a sub-pixel in another one of at least two different states; and
upon determining that the brightness of the sub-pixel in one of the at least two states is smaller than the brightness of the sub-pixel in another one of the at least two states, controlling the first time of the sub-pixel in one of the at least two states to be greater than the second time of the sub-pixel in another one of the at least two states.

32. The driving method according to claim 31, wherein a same sub-pixel in different states has a same target brightness.
